(19) United States
(12) Patent Application Publication
(10) Pub. No.: US 2014/0347378 A1
(43) Pub. Date: Nov. 27, 2014

(54) CONTROL DEVICE, CONTROL METHOD, AND PROGRAM

(71) Applicants: Takuya Mukai, Tokyo (JP); Yoshiaki Koizumi, Tokyo (JP)

(72) Inventors: Takuya Mukai, Tokyo (JP); Yoshiaki Koizumi, Tokyo (JP)

(73) Assignee: MITSUBISHI ELECTRIC CORPORATION, Tokyo (JP)

(21) Appl. No.: 14/369,415

(22) PCT Filed: Jan. 27, 2012
(86) PCT No.: PCT/JP2012/051865

§ 371 Date: Jun. 27, 2014

(51) Int. Cl. G09G 3/36; G09G 5/39

(52) U.S. Cl. CPC G09G 3/3696; G09G 5/39; G09G 2330/022; G09G 2330/028; G09G 2360/12
USPC 345/531; 345/87

(57) ABSTRACT

A remote control, upon determining that a power-saving flag is on, or in other words, upon determining that the remote control is conducting power-saving operating behavior, decides on a monochrome image stored in a reduced image memory as image information to be read by a renderer. The monochrome image has ⅛ the amount of information compared to a color image stored in a normal image memory. Consequently, in the case of power-saving operating behavior by the remote control, the renderer is able to read a monochrome image stored in the reduced image memory with less power compared to the case of reading a color image stored in the normal image memory. Consequently, power consumed in the remote control may be restricted in the case of power-saving operating behavior by the remote control.

### TECHNICAL FIELD

The present disclosure relates to a control device, a control method, and a program.

### BACKGROUND ART

The remote control device described in Patent Literature 1 is one technology that restricts power consumed by a control device that controls equipment to be controlled.

The remote control device described in Patent Literature 1 restricts power consumption by turning off a fluorescent display that illuminates the display screen of a display device in the case in which no control operation is performed by a user within an amount of time set by the user.

### CITATION LIST

### Patent Literature

Patent Literature 1: Unexamined Japanese Patent Application Kokai Publication No. 2006-349219

### SUMMARY OF INVENTION

### Technical Problem

At this point, in the case of applying the remote control device described in Patent Literature 1 to a remote control device for an air conditioner, for example, if a control operation such as setting the air conditioner temperature is repeatedly conducted within the set amount of time, the fluorescent display is not turned off. In other words, in this case, with the remote control device described in Patent Literature 1, the fluorescent display is kept on. Consequently, with the remote control device described in Patent Literature 1, there is a problem in that if a control operation is performed, the consumed power is not restricted in some cases.

The present disclosure, being devised in light of the above circumstances, takes as an object to provide a control device, a control method, and a program capable of minimizing consumed power, without being affected by the presence or absence of a control operation.

### Solution to Problem

In order to achieve the above object, a control device according to the present disclosure receives a control operation for controlling equipment to be controlled, and transmits control information according to the received control operation to the equipment to be controlled. A display displays a control screen. An information memory stores first image information, which is image information of image pixels that form a control screen displayed on the display. A reduced information memory stores second image information, which is image information of the image pixels, and which has an amount of information that is less than that of image information stored in the information memory. An operating mode setter sets an operating mode of the control device to one of a first operating mode that operates with designated power consumption, and a second operating mode with lower power consumption than the first operating mode. When the operating mode setter has set the first operating mode, a screen generator reads first image information stored in the information memory and generates a control screen made up of a plurality of image pixels, and when the operating mode setter has set the second operating mode, the screen generator reads second image information stored in the reduced information memory and generates a control screen made up of a plurality of image pixels, and displays the generated control screen on the display.

### Advantageous Effects of Invention

According to the present disclosure, in the case of entering a second operating mode, the power consumed when reading image information may be restricted compared to the case of a first operating mode. Consequently, according to the present disclosure, consumed power may be restricted, without being affected by the presence or absence of a control operation.

### BRIEF DESCRIPTION OF DRAWINGS

FIG. 1 is a block diagram of an air conditioning system according to a first embodiment of the present disclosure;

FIG. 2 is a diagram illustrating a relationship between output voltage and remaining charge in a storage battery;

FIG. 3 is a diagram illustrating connections among a storage battery, normal image memory and reduced image memory;

FIG. 4A is a display on an LCD using color image information stored in normal image memory,

FIG. 4B is a display on an LCD using monochrome image information stored in reduced image memory;

FIG. 5 is a flowchart illustrating a power-saving configuration process;

FIG. 6 is a flowchart illustrating a screen generation process;

FIG. 7 is a flowchart illustrating a power rerouting process;

FIG. 8 is a block diagram of an air conditioning system according to a second embodiment of the present disclosure;

FIG. 9 is a diagram illustrating connections among a power supply, normal image memory and reduced image memory;

FIG. 10 is a flowchart illustrating a power process; and

FIG. 11 is a flowchart illustrating a power-saving configuration process of an air conditioning system according to the second embodiment.

### DESCRIPTION OF EMBODIMENTS

### First Embodiment

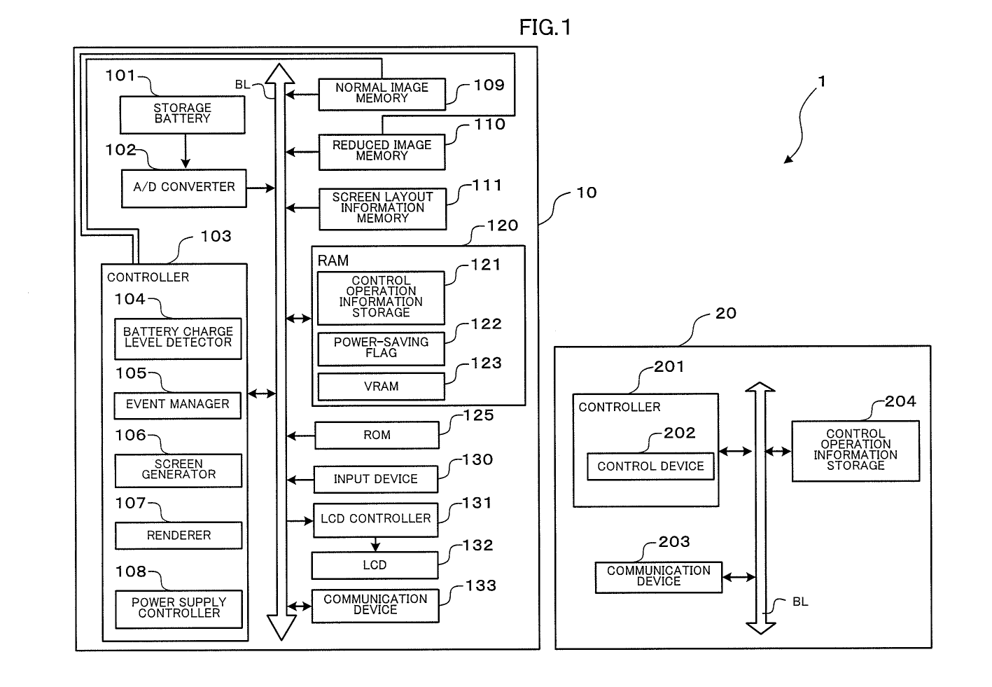

Hereinafter, an air conditioning system 1 according to the first embodiment of the present disclosure will be described with reference to FIGS. 1 to 7.

The air conditioning system 1 is equipped with a remote control 10 and an air conditioner 20.

The remote control 10 is a remote control (control device) that receives a control operation for controlling the air conditioner 20, and transmits a command (control information) according to the received control operation to the air conditioner 20. Specifically, the remote control 10 transmits to the air conditioner 20 a command to change the operating behavior of the air conditioner 20 (cooling, air circulation or heating) or to change the set temperature of the air conditioner 20. The remote control 10 is equipped with a storage battery 101, an A/D converter 102, a controller 103, normal image memory 109, reduced image memory 110, screen layout information memory 111, RAM (Random Access Memory) 120 (control operation information storage 121, a power-saving flag 122, VRAM (Video RAM) 123), ROM (Read-Only Memory) 125, an input device 130, an LCD controller 131, an LCD 132 and a communication device 133.

The storage battery 101 outputs DC power consumed by the remote control 10. Specifically, the storage battery 101 supplies DC power consumed by the respective components 102 to 133 of the remote control 10. The storage battery 101 may be a primary battery or a secondary battery.

The A/D (Analog/Digital) converter 102 is a converter that converts an output voltage of the storage battery 101 (analog value) into a digital value, and outputs that digital value to the controller 103 via a bus line BL.

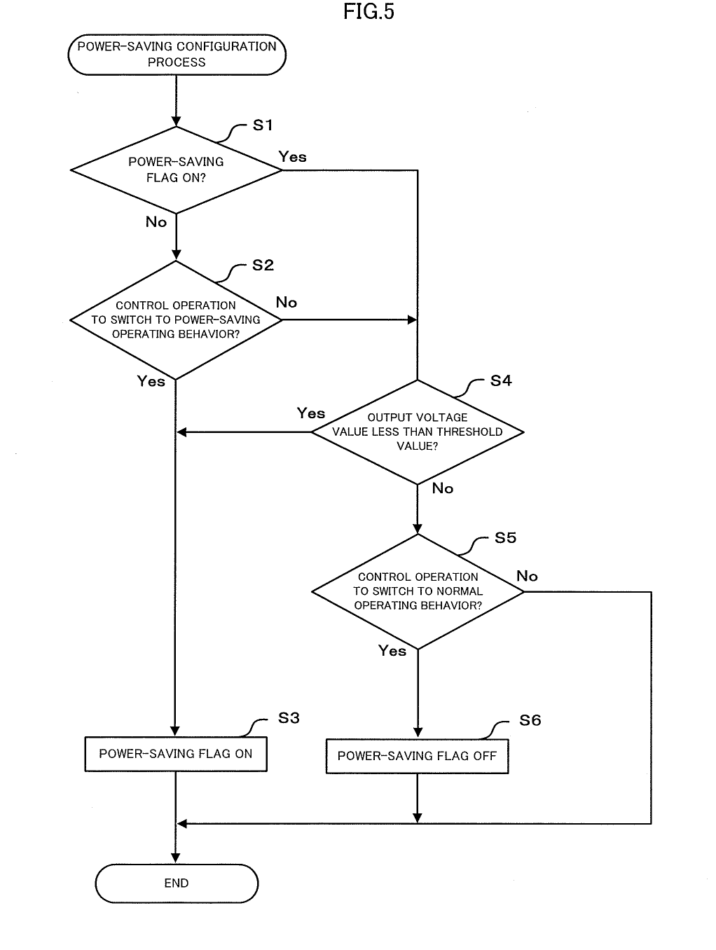

The controller 103 controls the remote control 10 by executing a program stored in the ROM 125 (for example, a program that realizes the processes illustrated in FIGS. 5 to 7 discussed later).

In addition, by executing a program stored in the ROM 125, the controller 103 realizes the functions of a battery charge level detector 104, an event manager 105, a screen generator 106, a renderer 107, and a power supply controller 108.

The battery charge level detector 104 compares the output voltage of the storage battery 101 output from the A/D converter 102 (a digital value) to a predetermined threshold value, and determines whether or not the output voltage of the storage battery 101 is less than the threshold value. As a result, the battery charge level detector 104 detects the remaining energy of the storage battery 101. Note that hereinafter, the remaining energy of the storage battery 101 is designated the “remaining charge”.

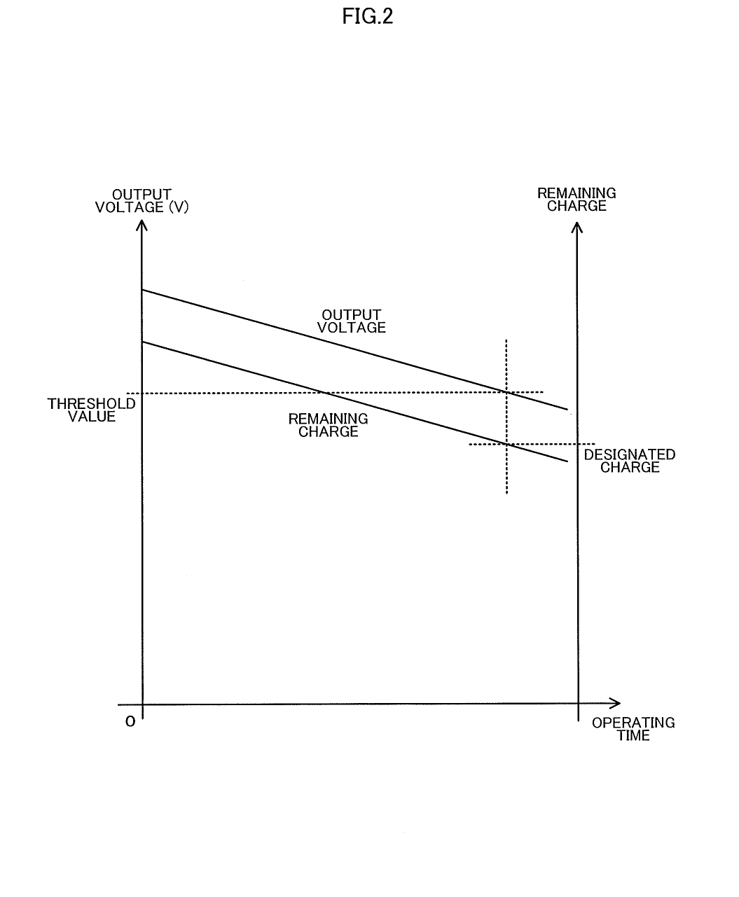

The relationship between the output voltage and the remaining charge in the storage battery 101 is as illustrated in FIG. 2. Namely, the relationship is such that as the output voltage of the storage battery 101 lowers, the remaining charge of the storage battery 101 also decreases. The battery charge level detector 104, by detecting that the detected output voltage of the storage battery 101 is less than the threshold value, indirectly detects that the remaining charge of the storage battery 101 is less than a designated charge.

Upon determining that the output voltage of the storage battery 101 is less than a threshold value, the battery charge level detector 104 switches on the power-saving flag 122, and the operating mode of the remote control 10 changes from normal operating behavior to power-saving operating behavior with lower power consumption than normal operating behavior. Note that in the case in which the power-saving flag 122 is already on, the battery charge level detector 104 keeps the power-saving, flag 122 in the on state, irrespectively of the comparison result between the output voltage of the storage battery 101 and the threshold value.

When a user performs a control operation on the input device 130, the event manager 105 executes a process according to that control operation. Specifically, when there is a control operation on the input device 130 that necessitates a change in the display content on the LCD 132 (hereinafter designated the “screen”), the event manager 105 references a table stored in the ROM 125 to extract the control operation content and a changed screen number. Herein, a screen number is a number that is uniquely assigned to each type of screen in order to identify that screen. For example, when the user performs a control operation that configures the shape (lengthwise or widthwise) of the room in which the air conditioner 20 is installed, the event manager 105 references the table, and specifies a screen number corresponding to a room shape configuration screen. As another example, when the user performs a control operation for configuring a setting related to internal cleaning of the air conditioner 20, the event manager 105 references the table, and specifies a screen number corresponding to a configuration screen related to cleaning. The screen number specified by the event manager 105 is used by the screen generator 106.

Additionally, in the case in which a change occurs in the operating behavior or configuration of the air conditioner 20 due to a control operation performed by the user on the input device 130, the event manager 105 causes the control operation information storage 121 in the RAM 120 to store the changed operating behavior or configuration. An operating behavior or configuration stored in the operation information storage 121 is hereinafter designated “control operation information”. Specifically, control operation information is information that indicates the control state of the air conditioner 20, such as the operating state of the air conditioner 20 (cooling, air circulation, heating) or the set temperature of the air conditioner 20, for example.

In addition, when the user performs a control operation with the input device 130 giving an instruction to switch to the power-saving operating behavior, the event manager 105 switches on the power-saving flag 122, and switches the operating state of the remote control 10 to the power-saving operating behavior. Also, when the user performs via the input device 130 a control operation to switch to the normal operating behavior, the event manager 105 switches off the power-saving flag 122, and switches the operating state of the remote control 10 to the normal operating behavior. This control operation to switch to the normal operating behavior by the user is valid while in the state in which the battery charge level detector 104 determines that the output voltage of the storage battery 101 is equal to or greater than the threshold value (in the state of detecting that the remaining charge of the storage battery 101 is equal to or greater than the designated charge), but becomes invalid while in the state in which the battery charge level detector 104 determines that the output voltage of the storage battery 101 is less than the threshold value (in the state of detecting that the remaining charge of the storage battery 101 is less than the designated charge).

The screen generator 106 acquires, from the screen layout information memory 111, screen layout information corresponding to a screen number extracted by the event manager 105. Subsequently, on the basis of the acquired screen layout information, the screen generator 106 decides on information to use for the screen (images and control operation information), and also decides on the screen layout (what images and control operation information are to be placed in which areas on the display screen of the LCD 132).

The above screen layout information includes information related to the display of an image constituting a screen, and is made up of display coordinates that specify an area on a display screen of the LCD 132 in which, an image is placed, normal image specifying information that specifies an image to display during the normal operating behavior, and power-saving image specifying information that specifies an image to display during the power-saving operating behavior. The normal image specifying information and the power-saving image specifying information include an image address indicating a storage location of an image in the normal image memory 109 or the reduced image memory 110 in the case in which the image to display does not change (the fixed case), and includes a type name corresponding to control operation information in addition to the image address in the case in which the image to display changes according to the control operation information. For example, in the case in which the type name corresponding to the control operation information is “set temperature”, the screen generator 106 acquires the numerical value of the set temperature from the control operation information storage 121, and specifies an image address of a number image corresponding to that numerical value.

After acquiring screen layout information corresponding to the screen number extracted by the event manager 105 from the screen layout information memory 111, the screen generator 106 reads the display coordinates of an image constituting a screen and an image address from the acquired screen layout information and specifies the display coordinates and image address to issue a render request to the renderer 107. A screen is generated as a result of the screen generator 106 issuing a render request for all images constituting the screen. At this point, the reference destination of an image address is switched depending on the operating state of the remote control 10, becoming the normal image memory 109 in the case in which the power-saving flag 122 is off (normal operating behavior), and becoming the reduced image memory 110 in the case in which the power-saving flag 122 is on (power-saving operating behavior). By switching in this way, when the power-saving flag 122 is switched from off to on, the screen generator 106 is able to generate a screen using the image address of a corresponding image after the switch that corresponds to an image constituting the screen that was being displayed on the LCD 132 immediately before the switch.

The renderer 107, upon receiving a render request from the screen generator 106, reads an image corresponding to the image address specified by the screen generator 106 from the normal image memory 109 or the reduced image memory 110, and writes the read-out image to an area in the VRAM 123 that corresponds to the display coordinates specified by the screen generator 106.

The power supply controller 108 monitors the power-saving flag 122, and controls the supply of power from the storage battery 101 to the normal image memory 109 and the reduced image memory 110 according to the operating state of the remote control 10. Specifically, in the case of normal operating behavior by the remote control 10, the power supply controller 108 supplies power from the storage battery 101 to the normal image memory 109, while shutting off power supply from the storage battery 101 to the reduced image memory 110. As a result, in the case of normal operating behavior by the remote control 10, the power supply controller 108 prevents power from being consumed by the memory from which the renderer 107 is not reading images, or in other words, by the reduced image memory 110.

On the other hand, in the case of power-saving operating behavior by the remote control 10, the power supply controller 108 supplies power from the storage battery 101 to the reduced image memory 110, while shutting off power supply from the storage battery 101 to the normal image memory 109. As a result, in the case of power-saving operating behavior by the remote control 10, the power supply controller 108 prevents power from being consumed by the memory from which the renderer 107 is not reading images, or in other words, by the normal image memory 109.

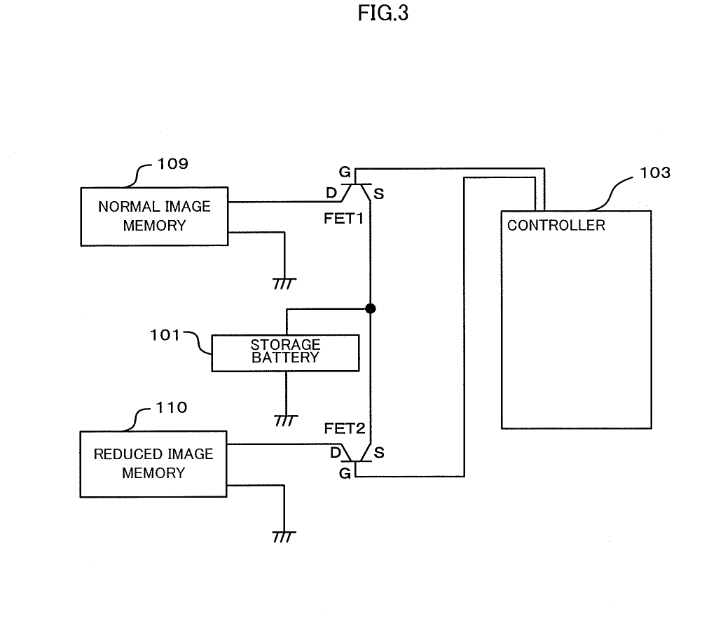

FIG. 3 illustrates a specific configuration by which the power supply controller 108 controls the supply of power from the storage battery 101 to the normal image memory 109 and the reduced image memory 110.

As illustrated in FIG. 3, the power supply controller 108 controls power supply to the normal image memory 109 with a field-effect transistor FET1. A power supply terminal of the normal image memory 109 is connected to the drain of the field-effect transistor FET1, a port of the controller 103 is connected to the gate of the field-effect transistor FET1 and a power supply terminal of the storage battery 101 is connected to the source of the field-effect transistor FET1. The power supply controller 108 controls power supply to the normal image memory 109 by switching the level of a first power supply control signal output to the drain of the field-effect transistor FET. Specifically, the power supply controller 108 sets the level of the first power supply control signal to high (hereinafter simply designated “F1”) to power the field-effect transistor FET1 and thereby supply power to the normal image memory 109, and sets the level of the first power supply control signal to low (hereinafter simply designated “L”) shut off the field-effect transistor FET1 and thereby shut off power supply to the normal image memory 109.

Similarly, the power supply controller 108 controls power supply to the reduced image memory 110 with a field-effect transistor FET2. A power supply terminal of the reduced image memory 110 is connected to the drain of the field-effect transistor FET2, a port of the controller 103 is connected to the gate of the field-effect transistor FET2 and a power supply terminal of the storage battery 101 is connected to the source of the field-effect transistor FET2. The power supply controller 108 controls power supply to the reduced image memory 110 by switching the level of a second power supply control signal output to the drain of the field-effect transistor FET2. Specifically, the power supply controller 108 sets the level of the second power supply control signal to “H” to power the field-effect transistor FET2 and thereby supply power to the reduced image memory 110, and sets the level of the first power supply control signal to “L” to shut off the field-effect transistor FET2 and thereby shut off power supply to the reduced image memory 110.

The normal image memory 109 is ROM, for example. The normal image memory 109 stores an image made up of pixels displayed on the LCD 132 during normal operating behavior. Herein, a stored image is a set of information expressing display colors for individual pixels to be displayed on the LCD 132, or in other words, image information. The normal image memory 109 may also store a compressed image that has been compressed according to a designated scheme such as the JPEG (Joint Photographic Experts Group) format. In this case, an image is written to the VRAM 123 after a decompressing a compressed image with the renderer 107 discussed above. The normal image memory 109 stores a color image able to specify 256 colors, for example.

The reduced image memory 110 is ROM, for example. The reduced image memory 110 stores an image made up of pixels displayed on the LCD 132 during power-saving operating behavior. Herein, a stored image is information corresponding to an image stored in the normal image memory 109, or in other words, image information. The reduced image memory 110 stores a two-color monochrome image, for example.

In this way, by storing in the reduced image memory 110 an image with a smaller quantity of information than an image stored in the normal image memory 109, the memory capacity of the reduced image memory 110 may be decreased compared to the normal image memory 109, and as a result, the power consumption used during operating behavior with the reduced image memory 110 may also be decreased.

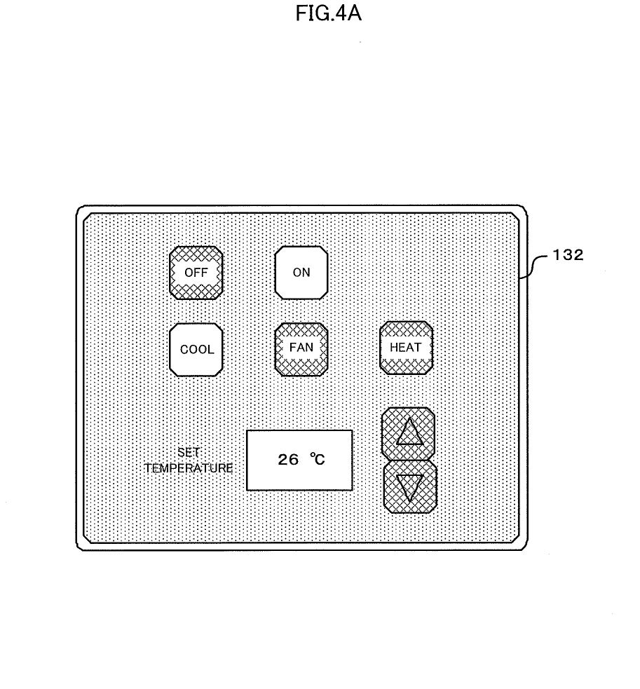

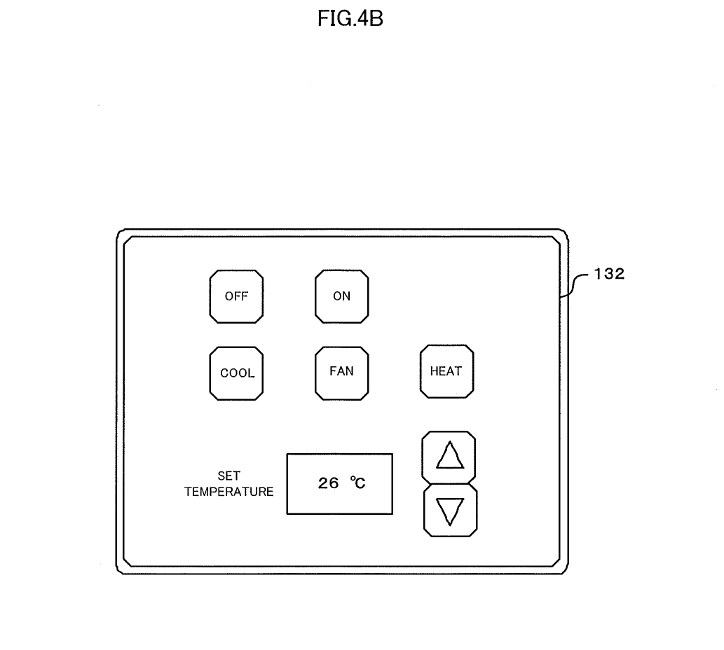

FIGS. 4A and 4B illustrate an exemplary screen using a color image stored in the normal image memory 109 and an exemplary screen using a monochrome image stored in the reduced image memory 110.

An exemplary screen using a color image is as illustrated in FIG. 4A, in which the text “ON” indicating that the air conditioner 20 is currently running, a text button “COOL” indicating that the air conditioner 20 is in cooling operation, and a display window of the set temperature “26° C.” are highlighted. Meanwhile, the text buttons “OFF”, “FAN”, “HEAT” and set temperature adjustment buttons made up of two upward and downward triangles are shaded with hatching. Furthermore, the background is also colored.

On the other hand, an exemplary screen using a monochrome image is as illustrated in FIG. 4B, in which the text buttons, the display window and the set temperature adjustment buttons are displayed in a solid color (for example, black).

As discussed above, two colors are usable in a monochrome image stored in the reduced image memory 110, whereas 256 colors are usable in a color image stored in the normal image memory 109. Thus, a monochrome image has ⅛ the amount of information compared to a color image. Consequently, in the case of power-saving operating behavior by the remote control 10, the renderer 107 is able to read a monochrome image stored in the reduced image memory 110 with less power compared to the case of reading a color image stored in the normal image memory 109. Consequently, power consumed in the remote control 10 may be restricted in the case of power-saving operating behavior by the remote control 10.

The screen layout information memory 111 illustrated in FIG. 1 stores screen layout information acquired by the screen generator 106. As discussed earlier, screen layout information stored in the screen layout information memory 111 is made up of display coordinates, normal image specifying information, and power-saving image specifying information.

The RAM 120 is equipped with the control operation information storage 121, the power-saving flag 122 and the VRAM 123.

The control operation information storage 121 stores information that indicates the control state of the air conditioner 20, such as the operating state of the air conditioner 20 (cooling, air circulation, heating) or the set temperature of the air conditioner 20, for example, as control operation information. In the case in which a change occurs in the control state of the air conditioner 20, the control operation information stored in the control operation information storage 121 is updated by the event manager 105.

The power-saving flag 122 decides whether the remote control 10 is conducting normal operating behavior, or alternatively, the remote control 10 is conducting power-saving, operating behavior. By switching on the power-saving flag 122, the remote control 10 conducts power-saving operating behavior, whereas by switching off the power-saving flag 122, the remote control 10 conducts normal operating behavior. The power-saving flag 122 is off immediately after activation of the remote control 10.

The VRAM 123 stores the display color of each pixel in one screen to be displayed on the LCD 132. By overwriting the stored content of the VRAM 123, the display content on the LCD 132 (the screen) is changed.

The input device 130 is a touch panel placed above the LCD 132, for example. From the user, the input device 130 receives an instruction to switch the operating state of the remote control 10 to normal operating behavior or power-saving operating behavior, an instruction to change the configuration of the air conditioner 20 or the like.

The Liquid Crystal Display (LCD) controller 131 reads the stored content of the VRAM 123 on a fixed cycle, and causes a screen corresponding to the content stored in the VRAM 123 to be displayed on the LCD 132.

The LCD 132 is a dot matrix liquid crystal display.

In the case in which the user performs a control operation via the input device 130, the communication device 133 transmits to the communication device 220 of the air conditioner 20 a command instructing a change in the control state, using infrared or radio waves, for example. The communication device 133 is able to transmit this command to the communication device 220 of the air conditioner 20 regardless of the operating state of the remote control 10, or specifically, whether the remote control 10 is conducting normal operating behavior or whether the remote control 10 is conducting power-saving operating behavior.

Thus, in the remote control 10, even if the remaining charge of the storage battery 101 becomes less than the designated value and the remote control 10 switches to power-saving, operating behavior, controlling the air conditioner 20 is still possible while minimizing the power consumed by the remote control 10. Consequently, in the remote control 10, control of the air conditioner 20 is possible over a longer time compared to a remote control that reads a color image even if the remaining charge of the storage battery 101 becomes less than a designated value.

The bus line BL interconnects the A/D converter 102, the controller 103, the normal image memory 109, the reduced image memory 110, the screen layout information memory 111, the RAM 120, the ROM 125, the input device 130, the LCD controller 131 and the communication device 133.

The air conditioner 20 is an air conditioner that adjusts the temperature and the like inside a room, and is equipped with a controller 201, a communication device 203 and control operation information storage 204.

The controller 201 controls the air conditioner 20. The controller 201 is equipped with a CPU (Central Processing Unit), ROM and RAM (not illustrated).

The controller 201 realizes the functions of a control device 202 by having the CPU execute a program stored in the ROM.

The control device 202 causes the air conditioner 20 to run in accordance with control operation information that indicates a control state of the air conditioner 20 stored in the control operation information storage 204.

The communication device 203 receives a command transmitted from the communication device 133 of the remote control 10.

A bus line BL interconnects the controller 201, the communication device 203 and the control operation information storage 204.

The control operation information storage 204 stores information that indicates the control state of the air conditioner 20, such as the operating state of the air conditioner 20 (cooling, air circulation, heating) or the set temperature of the air conditioner 20, as control operation information. In the case in which the communication device 203 receives a command and a change occurs in the control state of the air conditioner 20, the control operation information stored in the control operation information storage 204 is updated by the controller 201.

A power-saving configuration process executed by the remote control 10 discussed above will be described with reference to FIG. 5. The power-saving configuration process is a process that switches the power-saving flag 122 on/off. The power-saving, configuration process is executed periodically (thr example, every minute). Additionally, the power-saving configuration process is executed also in the case in which the user performs a control operation via the input device 130.

In the power-saving configuration process, first, the controller 103 determines whether or not the power-saving flag 122 is on (step S1).

The controller 103, upon determining that the power-saving flag 122 is off (step S1: No), proceeds to step S2.

In step Ω, the controller 103 (event manager 105) determines whether or not the input device 130 has received a control operation by the user instructing a switch to power-saving operating behavior (step S2).

In the case in which a control operation instructing a switch to power-saving operating behavior has been received (step S2: Yes), the controller 103 (event manager 105) switches on the power-saving flag 122 (step S3), and ends the power-saving configuration process.

On the other hand, in the case in which a control operation instructing a switch to power-saving operating behavior has not been received (step S2: No), the controller 103 (event manager 105) proceeds to step S4. Also, in the case of determining that the power-saving flag 122 is on in step S1 (step S1: Yes), the controller 103 likewise proceeds to step S4.

In step S4, the controller 103 (battery charge level detector 104) determines whether or not the output voltage of the storage battery 101 is less than a threshold value, or in other words, whether or not the remaining charge of the storage battery 101 is less than a designated charge (step S4).

The controller 103 (battery charge level detector 104), upon determining that the output voltage is less than the threshold value (step S4: Yes), detects that the remaining charge of the storage battery 101 is less than the designated charge, and thus executes step S3 and ends the power-saving configuration process. On the other hand, the controller 103 (battery charge level detector 104), upon determining that the output voltage is equal to or greater than the threshold value (step S4: No), detects that the remaining charge of the storage battery 101 is equal to or greater than the designated charge, and thus proceeds to step S5.

In step S5, the controller 103 (event manager 105) determines whether or not the input device 130 has received a control operation by the user instructing a switch to normal operating behavior (step S5).

Upon determining that a control operation instructing a switch to normal operating behavior has been received (step S5: Yes), the controller 103 (event manager 105) switches off the power-saving flag 122 (step S6) and ends the power-saving configuration process.

Upon determining that a control operation instructing a switch to normal operating behavior has not been received (step S5: No), the controller 103 (event manager 105) does not switch the power-saving flag 122 and ends the power-saving configuration process.

Configured as above, in the power-saving configuration process, the power-saving flag 122 is switched on/off, and the operating state of the remote control 10 is switched to either power-saving operating behavior or normal operating behavior.

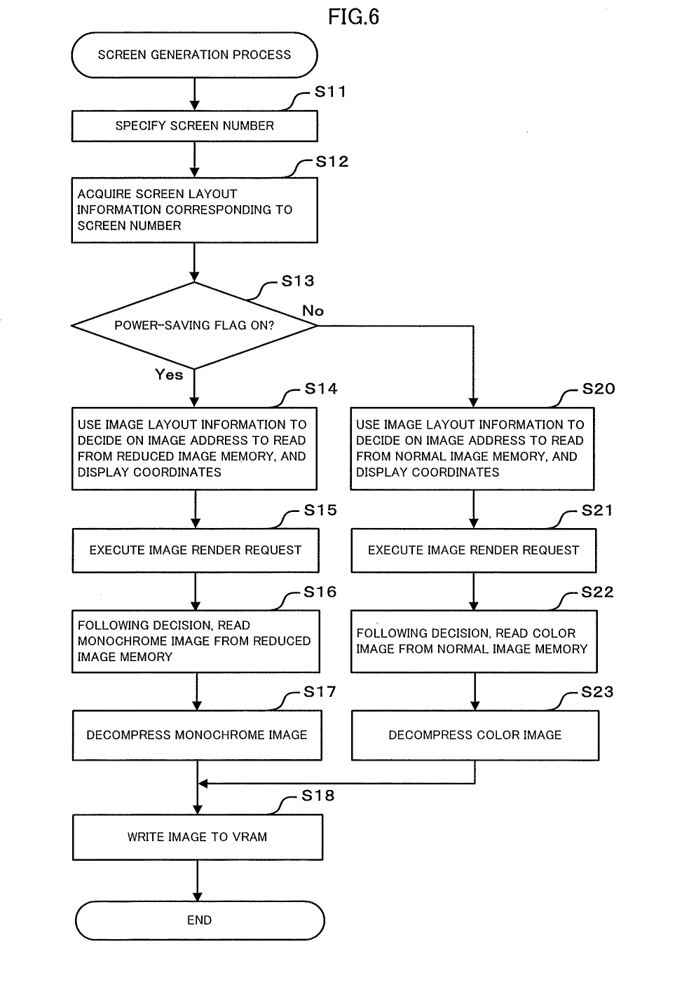

Next, a screen generation process executed by the remote control 10 will be described with reference to FIG. 6.

The screen generation process is executed in a case such as when the power-saving flag 122 is switched on/off, or when the user performs a control operation via the input device 130. In this screen generation process, an image stored in the normal image memory 109 and an image stored in the reduced image memory 110 will be described as compressed information.

In the screen generation process, first, the controller 103 (event manager 105) extracts a screen number indicating which screen to use for the change from a table stored in ROM (a table associating control operation content with a changed screen number) (step S11). Specifically, when the user performs a control operation that configures the shape (lengthwise or widthwise) of the room in which the air conditioner 20 is installed, the event manager 105 specifies a screen number corresponding to a room shape configuration screen, for example. As another example, when the user performs a control operation for configuring a setting related to internal cleaning of the air conditioner 20, the event manager 105 specifies a screen number corresponding to a configuration screen related to cleaning.

After that, the controller 103 (screen generator 106) acquires, from the screen layout information memory 111, screen layout information corresponding to the screen number specified by the event manager 105 (step S12).

After that, the controller 103 (screen generator 106) determines whether the power-saving flag 122 is on, or in other words, whether the remote control 10 is conducting power-saving operating behavior (step S13).

The controller 103 (screen generator 106), upon determining that the power-saving flag 122 is on, or in other words, upon determining that the remote control 10 is conducting power-saving operating behavior (step S13: Yes), decides on the display coordinates and image address of an image constituting the screen from the screen layout information (step S14). At this point, the image address is an address in the reduced image memory 110.

After that, the controller 103 (screen generator 106) specifies the image address and the display coordinates, and issues an image render request to the controller 103 (renderer 107) (step S15).

Subsequently, the controller 103 (renderer 107) follows the image address of the image decided in step S14, accesses the reduced image memory 110, reads a monochrome image (compressed image) from the reduced image memory 110 (step S16), decompresses the image (step S17), and writes the decompressed image to an area in the VRAM 123 corresponding to the decided display coordinates (step S18).

The controller 103, after conducting the processing from step S14 to step S18 above for all images on a screen to be displayed on the LCD 132, ends the screen generation process.

On the other hand, the controller 103 (screen generator 106), upon determining that the power-saving flag 122 is off, or in other words, upon determining that the remote control 10 is conducting normal operating behavior (step S13: No), decides on the image address and display coordinates of an image constituting the screen from the screen layout information (step S20). At this point, the image address is an address in the normal image memory 109.

After that, the controller 103 (screen generator 106) specifies the image address and the display coordinates, and issues an image render request to the controller 103 (renderer 107) (step S21).

Subsequently, the controller 103 (renderer 107) follows the image address of the image decided in step S20, accesses the normal image memory 109, reads a color image (compressed image) from the normal image memory 110 (step S22), decompresses the image (step S23) and writes the decompressed image to an area in the VRAM 123 corresponding to the decided display coordinates (step S18).

The controller 103, after conducting the processing from step S20 to step S22 and step S18 above for all images on a screen to be displayed on the LCD 132, ends the screen generation process.

By executing the screen generation process discussed above, when the power-saving flag 122 is switched from off to on, the remote control 10 is able to read a monochrome image from the reduced image memory 110 using the image address of a corresponding image after the switch that corresponds to an image constituting the screen that was being displayed on the LCD 132 immediately before the switch, and use the read-out monochrome image to generate and display a screen on the LCD 132.

At this point, the monochrome image stored in the reduced image memory 110 has ⅛ the amount of information per pixel compared to a color image stored in the normal image memory 109. Consequently, when the power-saving flag 122 is on (when the remote control 10 is conducting power-saving operating behavior), the amount of information transfer when the renderer 107 reads from the reduced image memory 110 or writes to the VRAM 123 may be restricted compared to when the remote control 10 is conducting normal operating behavior, and a screen may be rendered in a short amount of time. Consequently, by presenting a monochrome display during power-saving operating behavior, the remote control 10 is able to restrict consumed power.

Note that in the case in which the image stored in the normal image memory 109 and the image stored in the reduced image memory 110 are uncompressed, step S17 and step S23 may be skipped.

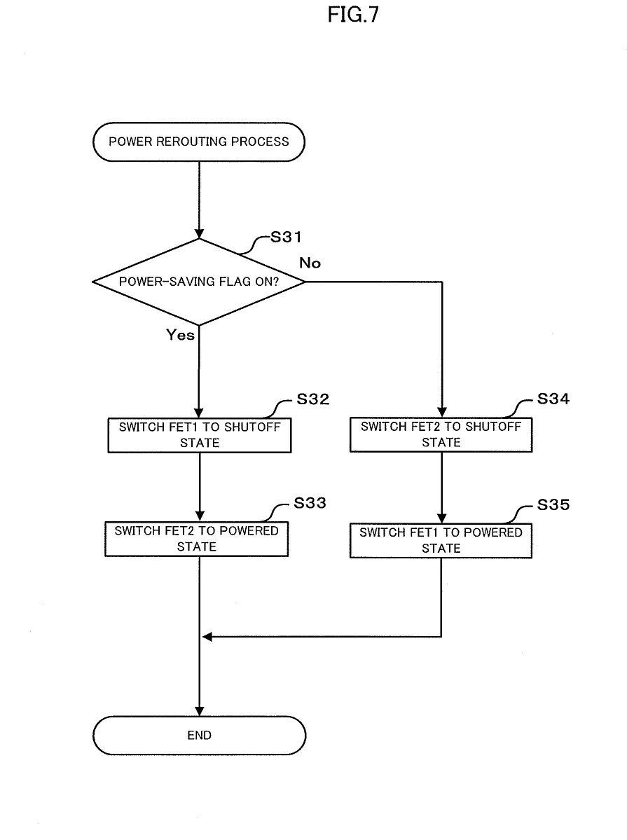

Next, a power rerouting process executed by the remote control 10 will be described with reference to FIG. 7. The power rerouting process is a process that supplies DC power from the storage battery 101 to either the normal image memory 109 or the reduced image memory 110, according to the on/off state of the power-saving flag 122, or in other words, according to whether the remote control 10 is conducting power-saving operating behavior or normal operating behavior. The power rerouting process is executed when the power-saving flag 122 is switched on/off.

In the power rerouting process, first, the controller 103 (power supply controller 108) determines whether or not the power-saving flag 122 is on (step S31).

The controller 103 (power supply controller 108), upon determining that the power-saving flag 122 is on, or in other words, that the remote control 10 is conducting power-saving operating behavior (step S31: Yes), switches the first power supply control signal to “L” to put the field-effect transistor FET1 in a shutoff state (step S32).

After that, the controller 103 (power supply controller 108) switches the second power supply control signal to “H” to put the field-effect transistor FET2 in a powered state (step S33).

After that, the controller 103 (power supply controller 108) ends the power rerouting process.

In other words, in the case of power-saving operating behavior by the remote control 10, the controller 103 (power supply controller 108) prevents power from being consumed by the memory from which the renderer 107 is not reading images, or in other words, by the normal image memory 109.

On the other hand, the controller 103 (power supply controller 108), upon determining that the power-saving flag 122 is off, or in other words, that the remote control 10 is conducting normal operating behavior (step S31: No), switches the second power supply control signal to “L” to put the field-effect transistor FET2 in a shutoff state (step S34).

After that, the controller 103 (power supply controller 108) switches the first power supply control signal to “H” to put the field-effect transistor FET1 in a powered state (step S35).

After that, the controller 103 (power supply controller 108) ends the power rerouting process.

In other words, in the case of normal operating behavior by the remote control 10, the controller 103 (power supply controller 108) prevents power from being consumed by the memory from which the renderer 107 is not reading images, or in other words, by the reduced image memory 110.

As discussed above, the remote control 10 of an air conditioning system 1 according to the first embodiment, upon determining that the power-saving flag 122 is on, or in other words, upon determining that the remote control 10 is conducting power-saving operating behavior, decides on a monochrome image stored in the reduced image memory 110 as the image to be read by the renderer 107. The monochrome image has ⅛ the amount of information compared to a color image stored in the normal image memory 109. Consequently, in the case of power-saving operating behavior by the remote control 10, the renderer 107 is able to read a monochrome image stored in the reduced image memory 110 with less power compared to the case of reading a color image stored in the normal image memory 109. Consequently, power consumed in the remote control 10 may be restricted in the case of power-saving operating behavior by the remote control 10. In addition, in the case of power-saving operating behavior by the remote control 10, the remote control 10 decides on a monochrome image stored in the reduced image memory 110 as the image to be read by the renderer 107, regardless of the presence or absence of a control operation on the input device 130. Thus, the remote control 10 is able to restrict consumed power without being affected by the presence or absence of a control operation.

In addition, the remote control 10, upon determining that the power-saving flag 122 is on, or in other words, upon determining that the remote control 10 is conducting power-saving operating behavior, shuts off power supply from the storage battery 101 to the memory from which the renderer 107 is not reading images, or in other words, to the normal image memory 109. As a result, in the case of power-saving operating behavior by the remote control 10, the remote control 10 prevents power from the storage battery 101 from being consumed by the normal image memory 109. Consequently, power consumed in the remote control 10 may be restricted in the case of power-saving operating behavior by the remote control 10.

Also, in the remote control 10, even if the remaining charge of the storage battery 101 becomes less than the designated value and the remote control 10 switches to power-saving operating behavior, controlling the air conditioner 20 is still possible while minimizing the power consumed by the remote control 10. Consequently, in the remote control 10, control of the air conditioner 20 is possible over a longer time compared to a remote control that reads a color image even if the remaining charge of the storage battery 101 becomes less than a designated charge.

Also, an image stored in the reduced image memory 110 has fewer usable colors in an image stored in the normal image memory 109. Thus, during development of the remote control 10, an image to be stored in the reduced image memory 110 may be created by repurposing an image to be stored in the normal image memory 109. Consequently, the image development period and development costs may be restricted compared to the case of creating an image to be stored in the reduced image memory 110 without repurposing an image to be stored in the normal image memory 109,

### Second Embodiment

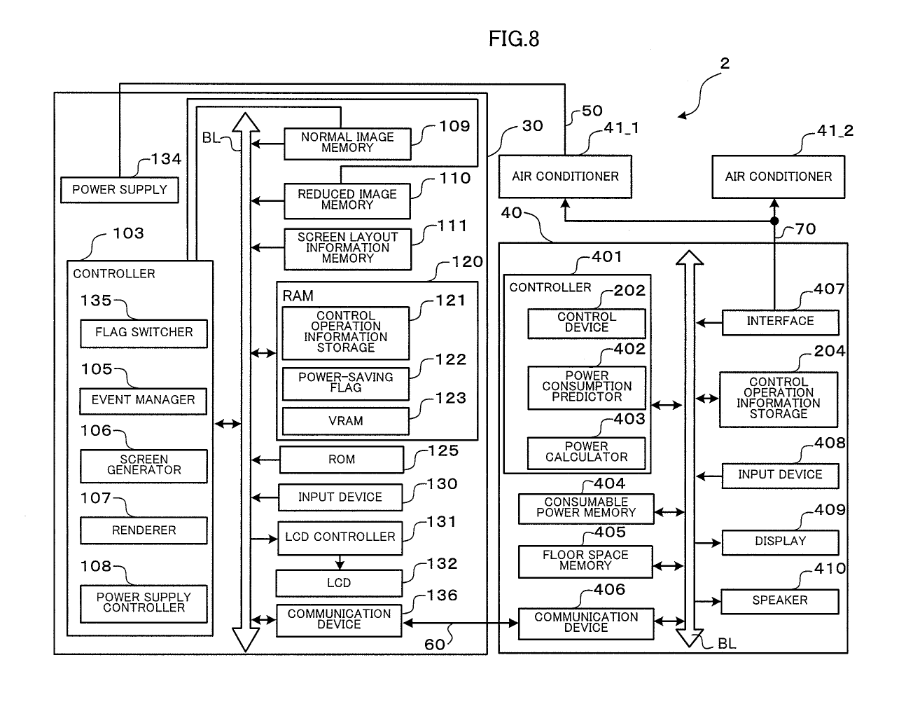

Next, an air conditioning system 2 according to the second embodiment of the present disclosure will be described with reference to FIGS. 8 to 10. The air conditioning system 2 is a partial modification of the configuration and processes of the air conditioning system 1 according to the first embodiment. Consequently, in the air conditioning system 2, components and operating behavior (processes) that are the same as the air conditioning system 1 will be denoted with the same numbers, and description thereof will be reduced or omitted.

The air conditioning system 2 is equipped with a remote control 30, a controller 40, air conditioners 41_1 and 41_2, a power cable 50, a communication cable 60 and a control cable 70.

The remote control 30 is a remote control that controls the air conditioner 41_1 via the controller 40. Note that the air conditioner 41_2 is the same model as the air conditioner 41_1, and is controlled via the controller 40 by another remote control 30 separate from the remote control 30.

The remote control 30 operates by consuming DC power supplied via the power cable 50 from the air conditioner 41_1. For this reason, the remote control 30 omits the storage battery 101, the A/D converter 102, and the battery charge level detector 104 from the remote control 10 of the first embodiment. In addition, the communication device 133 is changed to the communication device 136. On the other hand, the remote control 30 is equipped with a power supply 134 and a flag switcher 135 not included in the remote control 10 of the first embodiment.

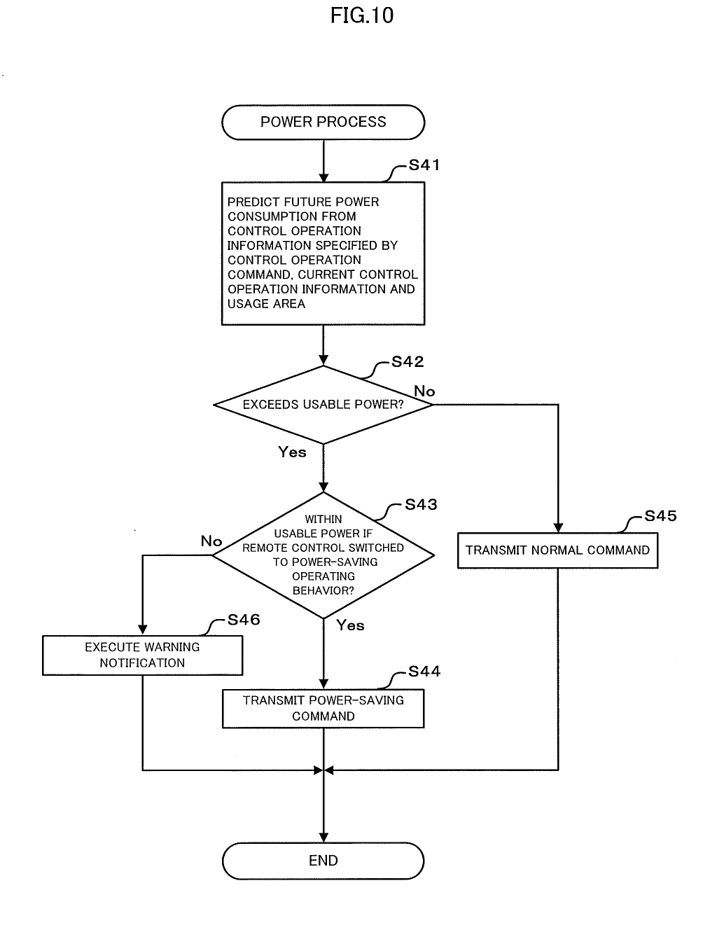

In addition, similarly to the remote control 10 of the first embodiment, the remote control 30 executes a power-saving configuration process (see FIG. 5), a screen generation process (see FIG. 6) and a power rerouting process (see FIG. 7). However, the remote control 30 executes a power-saving configuration process (FIG. 10) with process content that partially differs from the power-saving configuration process executed by the remote control 10 (see FIG. 5). Note that for the screen generation process and the power rerouting process, the remote control 30 executes the same processes as the remote control 10.

The power supply 134 of the remote control 30 supplies a DC voltage to the respective components 103 to 136 and the bus line BL of the remote control 30 by levering the voltage of a DC voltage supplied from the air conditioner 41_1 via the power cable 50, fix example. The DC voltage supplied from the air conditioner 41_1, unlike the DC voltage supplied from the storage battery 101 (see FIG. 1), is stable and does not decrease over time. For this reason, the A/D converter 102 and the battery charge level detector 104 used to detect the supply power (battery charge level) of the storage battery 101 in the remote control 10 are unnecessary in the remote control 30.

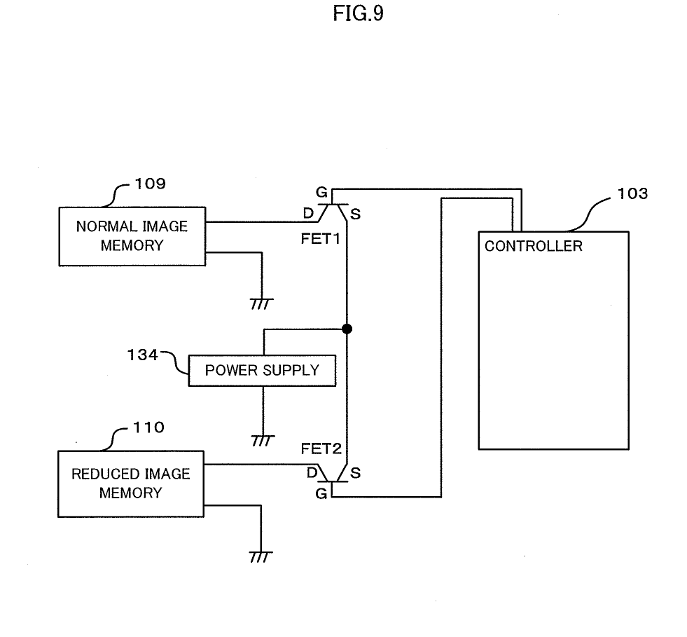

Herein, the configuration that supplies DC power to the normal image memory 109 and the reduced image memory 110 from the power supply 134 instead of the storage battery 101 is as illustrated in FIG. 9.

Specifically, a power supply terminal of the power supply 134 is connected to each source of the field-effect transistor FET1 and the field-effect transistor FET2, and a ground terminal of the power supply 134 is grounded.

The flag switcher 135 illustrated in FIG. 8 is a function realized by the controller 103 executing a program stored in the ROM 125. The flag switcher 135 switches on the power-saving flag 122 in the case of receiving via the communication device 136 a power-saving command that switches the operating state of the remote control 30 from normal operating behavior to power-saving operating behavior. On the other hand, the flag switcher 135 switches off the power-saving flag 122 in the case of receiving via the communication device 136 a normal command that switches the operating state of the remote control 30 from power-saving operating behavior to normal operating behavior.

The communication device 136 communicates with a communication device 406 of the controller 40 via the communication cable 60. Specifically, in the case in which the user performs a control operation via the input device 130, the communication device 136 transmits to the communication device 406 of the controller 40 a command instructing a change in the control state of the air conditioner 41_1. Also, if a normal command or a power-saving command that changes the operating state of the remote control 30 is transmitted from the communication device 406 of the controller 40, the communication device 136 receives the command.

The communication device 136 is able to transmit or receive such commands regardless of the operating state of the remote control 30, or specifically, whether the remote control 30 is conducting normal operating behavior or whether the remote control 30 is conducting power-saving operating behavior. Consequently, the remote control 30 is still able to control the air conditioner 41_1 even if the remote control 30 switches to power-saving operating behavior.

The controller 40 controls the operating behavior and the like of the air conditioner 41_1 and the air conditioner 41_2. The controller 40 is equipped with the control device 202 and the control operation information storage 204 included in the air conditioner 20 of the first embodiment. Furthermore, the controller 40 is equipped with following components not included in the air conditioner 20 of the first embodiment, namely, a controller 401, contracted power memory 404, floor space memory 405, a communication device 406, an interface 407, an input device 408, a display 409, and a speaker 410.

The controller 401 controls the operating behavior and the like of the air conditioner 41_1 and the air conditioner 41_2. The controller 401 is equipped with a central processing unit (CPU), ROM, and RAM (not illustrated).

The CPU executes a program stored in the ROM (for example, a program that realizes the process illustrated in FIG. 10 discussed later).

Also, by having the CPU execute a program stored in the ROM, the controller 401 realizes the functions of a power consumption predictor 402 and a power calculator 403, in addition to the control device 202 realized by the air conditioner 20 of the first embodiment.

The power consumption predictor 402 predicts the power consumption per unit time required in the case of realizing, in the air conditioner 41_1, a change in the control state specified by the user via the remote control 30. Specifically, the power consumption predictor 402 computes a difference between a change in the control state specified by the user via the remote control 30 and the current control state indicated by the control operation information stored in the control operation information storage 204 (such as the difference between a newly specified set temperature and the current set temperature, or the difference between a newly specified set humidity and the current set humidity, for example), and computes the required caloric consumption from this difference and the floor space of the room in which the air conditioner 41_1 is being used (a value stored in the floor space memory 405). Subsequently, the power consumption predictor 402 predicts the required power consumption per unit time from the computed caloric consumption.

The power calculator 403 determines whether the power consumption per unit time predicted by the power consumption predictor 402 exceeds a consumable power assigned as the power that may be consumed by the air conditioner 41_1 and the air conditioner 41_2 (consumable power per unit time).

In addition, in the case in which the power consumption per unit time predicted by the power consumption predictor 402 exceeds the consumable power, the power calculator 403 computes whether it is possible to remain within the consumable power by switching the remote control 30 to power-saving operating behavior. Specifically, the power calculator 403 subtracts the reduction in power consumption obtained in the case of switching the remote control 30 to power-saving operating behavior from the power consumption per unit time predicted by the power consumption predictor 402, and determines whether or not the reduced power consumption per unit time is within the consumable power.

Subsequently, the power calculator 403, upon determining that the reduced power consumption per unit time is within the consumable power, transmits a power-saving command that switches the remote control 30 to power-saving operating behavior to the remote control 30 via the communication device 406.

The consumable power memory 404 stores a consumable power assigned as the power that may be consumed by the air conditioner 41_1 and the air conditioner 41_2. The consumable power stored in the consumable power memory 404 is set by the user with a control operation on the input device 408. A contracted power under contract with a power company is stored in the consumable power memory 404, for example.

The floor space memory 405 stores the floor space of the room in which the air conditioner 41_1 is being used. The floor space stored in the floor space memory 405 is set by the user via the input device 408.

The communication device 406 communicates with the communication device 136 of the remote control 30 via the communication cable 60. Specifically, the communication device 406 transmits a normal command or a power-saving command that changes the operating state of the remote control 30 to the communication device 136 of the remote control 30. Also, if a command instructing a change in the control state of the air conditioner 41_1 is transmitted from the communication device 136 of the remote control 30, the communication device 406 receives the command.

The interface 407 transmits a signal that controls the operating behavior or the like of the air conditioner 41_1 or the air conditioner 41_2 via the control cable 70.

The input device 408 is a keyboard, for example. The input device 408 receives input by the user of a consumable power to be stored in the consumable power memory 404 and a floor space to be stored in the floor space memory 405.

The display 409 is a liquid crystal display, for example. The display 409 displays a warning in cases such as when the power calculator 403 determines that the power consumption per unit time predicted by the power consumption predictor 402 will exceed the consumable power even if the remote control 30 is switched to power-saving operating behavior.

In the case in which a warning is displayed on the display 409, the speaker 410 outputs a matching warning sound.

A power process executed by the controller 40 discussed above will be described with reference to FIG. 10. The power process predicts the power consumption per unit time required in the case of realizing, in the air conditioner 41_1, a change in the control state specified by the user. Also, the power process determines whether or not the predicted power consumption per unit time exceeds the consumable power. This power process is executed in the case in which the controller 40 receives a command instructing a change in the control state of the air conditioner 41_1.

In the power process, first, the controller 401 (power consumption predictor 402) executes the following process in step S41. Namely, the controller 401 (power consumption predictor 402) computes a difference between a change in the control state specified by the user via the remote control 30 and the current control state indicated by the control operation information stored in the control operation information storage 204 (such as the difference between a newly specified set temperature and the current set temperature, or the difference between a newly specified set humidity and the current set humidity, for example), and computes the required caloric consumption from this difference and the floor space of the room in which the air conditioner 41_1 is being used (a value stored in the floor space memory 405). Subsequently, the controller 401 (power consumption predictor 402) predicts the required power consumption per unit time from the computed caloric consumption.

Next, the controller 401 (power calculator 403) determines whether the power consumption per unit time predicted by the controller 401 (power consumption predictor 402) exceeds a consumable power assigned as the power that may be consumed by the air conditioner 41_1 and the air conditioner 41_2, or in other words, the consumable power stored in the consumable power memory 404 (step S42).

The controller 401 (power calculator 403, upon determining that the power consumption per unit time predicted by the controller 401 (power consumption predictor 402) exceeds the consumable power (step S42: Yes), makes the following determination in step S43. Namely, the controller 401 (power calculator 403) subtracts the reduction in power consumption obtained in the case of switching the remote control 30 to power-saving operating behavior from the power consumption per unit time predicted by the controller 401 (power consumption predictor 402), and determines whether or not the subtracted power consumption per unit time is within the consumable power (step S43).

The controller 401 (power calculator 403), upon determining that the reduced power consumption per unit time is within the consumable power (step S43: Yes), transmits a power-saving command that switches the remote control 30 to power-saving, operating behavior to the remote control 30 via the communication device 406 (step S44).

On the other hand, the controller 401 (power calculator 403), upon determining that the reduced power consumption per unit time exceeds the consumable power (step S43: No), starts executing a warning notification using the display 409 and the speaker 410 (step S46). This notification is continued until step S44 or step S45 is executed.

In step S42, if the controller 401 (power calculator 403) determines that the power consumption per unit time predicted by the controller 401 (power consumption predictor 402) is within the consumable power (step S42: Yes), it is not necessary to switch the remote control 30 to power-saving operating behavior, and thus the controller 401 (power calculator 403) transmits a normal command that switches the remote control 30 to normal operating behavior to the remote control 30 via the communication device 406 (step S45).

The controller 401 (power calculator 403) ends the power process after executing one of step S44, step S45 and step S46.

As discussed above, in the case in which the power consumption per unit time predicted by the power consumption predictor 402 exceeds the consumable power, the power calculator 403 subtracts the reduction in power consumption obtained in the case of switching the remote control 30 to power-saving operating behavior from the power consumption per unit time predicted by the power consumption predictor 402. Subsequently, in the case in which the reduced power consumption per unit time is within the consumable power, the power calculator 403 transmits a power-saving command to the remote control 30.

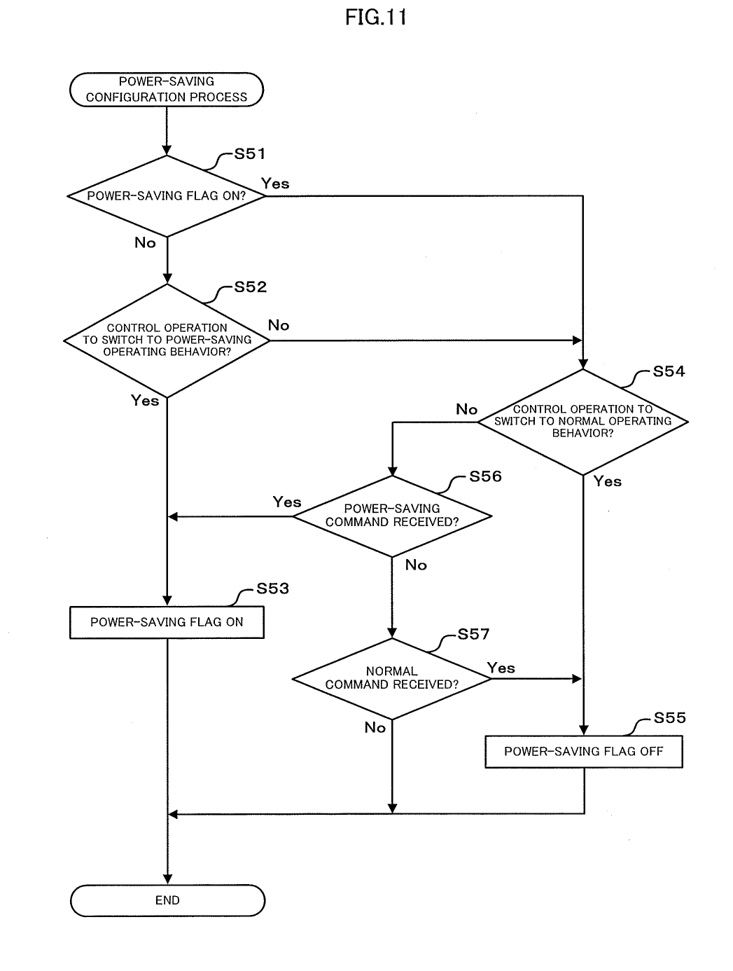

Next, a power-saving configuration process executed by the remote control 30 (a process with content that partially differs from the power-saving configuration process executed by the remote control 10) will be described with reference to FIG. 11. The power-saving configuration process is a process that switches the power-saving flag 122 on/off. The power-saving configuration process is executed in the case in which the user performs a control operation via the input device 130, or in the case of receiving a command from the controller 40.

In the power-saving configuration process executed by the remote control 30, first, the controller 103 (CPU) determines whether or not the power-saving fag 122 is on (step S51).

The controller 103, upon determining that the power-saving flag 122 is off (step S51: No), proceeds to step S52.

In step S52, the controller 103 (event manager 105) determines whether or not the input device 130 has received a control operation by the user for switching to power-saving operating behavior (step S52).

In the case in which a control operation instructing a switch to power-saving operating behavior has been received (step S52: Yes), the controller 103 (event manager 105) switches on the power-saving flag 122 (step S53), and ends the power-saving configuration process.

On the other hand, in the case in which a control operation instructing a switch to power-saving operating behavior has not been received (step S52: No), the controller 103 (event manager 105) proceeds to step S54. Also, in the case of determining that the power-saving flag 122 is on in step S51 (step S51: Yes), the controller 103 likewise proceeds to step S54.

In step S54, the controller 103 (event manager 105) determines whether or not the input device 130 has received a control operation by the user for switching to normal operating behavior (step S54).

Upon determining that a control operation instructing a switch to normal operating behavior has been received (step S54: Yes), the controller 103 (event manager 105) switches off the power-saving flag 122 (step S55), and ends the power-saving configuration process.

On the other hand, upon determining that a control operation instructing a switch to normal operating behavior has not been received (step S54: No), the controller 103 (event manager 105) proceeds to step S56.

In step S56, the controller 103 (flag switcher 135) determines whether or not the communication device 136 has received a power-saving command (step S56).

In step S56, the controller 103 (flag switcher 135), upon determining that a power-saving command has been received (step S56: Yes), switches on the power-saving flag 122 (step S53) in order to bring the power consumed by the air conditioner 41_1, the air conditioner 41_2 and the remote control 30 within the consumable power, and ends the power-saving configuration process.

On the other hand, the controller 103 (flag switcher 135), upon determining that the power-saving command has not been received (step S56: No), determines whether or not the communication device 136 has received a normal command (step S57).

The controller 103 (flag switcher 135), upon determining that the normal command has been received (step S57: Yes), switches off the power-saving flag 122 (step S55) in order to switch the remote control 30 to normal operating behavior, and ends the power-saving configuration process.

On the other hand, the controller 103 (flag switcher 135), upon determining that the normal command has not been received (step S57: No), ends the power-saving configuration process.

Configured as above, in the power-saving configuration process, the power-saving flag 122 is switched on/off according to a control operation performed by the user via the input device 130 or a command received from the controller 40, and the operating state of the remote control 30 is switched to either power-saving operating behavior or normal operating behavior.

As discussed above, the remote control 30 of the air conditioning system 2 according to the second embodiment switches to power-saving operating behavior upon receiving a power-saving command from the controller 40. Subsequently, in the image layout process, the remote control 30 decides on a monochrome image stored in the reduced image memory 110 as the image to be read by the renderer 107, similarly to the remote control 10 of the air conditioning system 1 according to the first embodiment. The monochrome image has ⅛ the amount of information compared to a color image stored in the normal image memory 109. Consequently, in the case of power-saving operating behavior by the remote control 30, the renderer 107 is able to read a monochrome image stored in the reduced image memory 110 with less power compared to the case of reading a color image stored in the normal image memory 109. Consequently, the remote control 30 is able to restrict consumed power in the case of power-saving operating behavior by the remote control 30. In addition, in the case of power-saving operating behavior by the remote control 10, the remote control 30 decides on a monochrome image stored in the reduced image memory 110 as the image to be read by the renderer 107, regardless of the presence or absence of a control operation on the input device 130. Thus, the remote control 30 is able to restrict consumed power without being affected by the presence or absence of a control operation.

In addition, the remote control 30, upon determining that the power-saving flag 122 is on, or in other words, upon determining that the remote control 10 is conducting power-saving operating behavior, shuts off power supply from the power supply 134 to the memory from which the renderer 107 is not reading images, or in other words, to the normal image memory 109. As a result, in the case of power-saving operating behavior by the remote control 30, the remote control 30 prevents power from the power supply 134 from being consumed by the normal image memory 109. Consequently, power consumed in the remote control 30 may be restricted in the case of power-saving operating behavior by the remote control 30.

The foregoing thus describes embodiments of the present disclosure, but the present disclosure is not limited to the above embodiments, and various modifications and applications are possible.

For example, the foregoing embodiments use a monochrome image with two usable colors as an example of an image stored in the reduced image memory 110, but are not limited thereto. In other words, an image stored in the reduced image memory 110 may also be, for example, an image of lower resolution than the resolution of an image stored in the normal image memory 109. Such an image of lower resolution is exemplified by an image with a smaller number of pixels than the number of pixels constituting an image stored in the normal image memory 109, for example. In this way, by making the resolution of an image stored in the reduced image memory 110 lower than the resolution of an image stored in the normal image memory 109, the amount of information in an image stored in the reduced image memory 110 may be reduced compared to an image stored in the normal image memory 109. Thus, in the case in which the operating state is power-saving operating behavior, the power consumed when reading an image on the remote control 10 and the remote control 30 may be restricted compared to the case in which the operating state is normal operating behavior. Consequently, in the case in which the operating state is power-saving operating behavior, the consumed power may be restricted.

As another example, in the case of using a gradation in an image stored in the normal image memory 109, an image stored in the reduced image memory 110 may be a solid color image that does not use a gradation. In this case, a lossless compression scheme able to compress an image made up of a solid color at a high compression ratio, such as a rum-length scheme or the PackBits scheme, may be applied to an image stored in the reduced image memory 110. As a result, the compression ratio of an image stored in the reduced image memory 110 is raised, and the amount of information in an image stored in the reduced image memory 110 may be further reduced compared to the amount of information in an image stored in the normal image memory 109. Thus, in the case in which the operating state is power-saving operating behavior, the power consumed when reading an image on the remote control 10 and the remote control 30 may be restricted compared to the case in which the operating state is normal operating behavior. Consequently, in the case in which the operating state is power-saving operating behavior, the consumed power may be restricted.

In addition, in general, ROM has lower power consumption as the memory capacity decreases. Thus, in the case of using ROM for the reduced image memory 110 and the normal image memory 109, by making the memory capacity of the reduced image memory 110 less than the memory capacity of the normal image memory 109 as illustrated with the remote control 10, the power consumption of the reduced image memory 110 may be restricted compared to the normal image memory 109.

In addition, in the case in which the reduced image memory 110 and the normal image memory 109 are other than ROM, such as a hard disk, for example, it is sufficient to use one in which the rated power consumption for the reduced image memory 110 is less than the rated power consumption for the normal image memory 109. As a result, the power consumption of the reduced image memory 110 likewise may be restricted compared to the normal image memory 109.

In addition, the remote control 10 and the remote control 30 in the foregoing respective embodiments are described as storing compressed images in the normal image memory 109 and the reduced image memory 110, but are not limited thereto. In other words, an uncompressed image may be stored in the normal image memory 109 while a compressed image is stored in the reduced image memory 110, so that the amount of information in an image stored in the reduced image memory 110 may be less than the amount of information in an image stored in the normal image memory 109. Also, if the amount of information in an image stored in the reduced image memory 110 is less than the amount of information in an image stored in the normal image memory 109, uncompressed images may also be stored in the normal image memory 109 and the reduced image memory 110.

Also, in the foregoing embodiments, an image constituting a screen displayed on the display screen of the LCD 132 is generated by a renderer 107 realized by a controller 103 executing a program stored in the ROM 125, but is not limited thereto. Instead of the renderer 107, a hardware-based graphic accelerator may also be used. In this case, the graphic accelerator may take the following configuration, similarly to the renderer 107. Namely, the graphic accelerator may be configured such that, upon receiving a render request from the screen generator 106, the graphic accelerator reads an image corresponding to the image address specified by the screen generator 106 from the normal image memory 109 or the reduced image memory 110, and writes the read-out image to an area in the VRAM 123 that corresponds to the display coordinates specified by the screen generator 106.

Also, the foregoing embodiments switch between powering and shutting off the reduced image memory 110 and the normal image memory 109 to thereby prevent the consumption of power by the memory from which an image is not being read, but are not limited thereto. In other words, in the case in which the controller 103 is able to control the supply or non-supply of a clock signal from the controller 103 used for operating behavior of the reduced image memory 110 and the normal image memory 109, the consumption of power by the memory from which an image is not being read may be prevented with the following configuration.

Namely, in the case in which the remote control 10 or the remote control 30 is conducting normal operating behavior, the controller 103 (power supply controller 108) stops supplying a clock signal to the reduced image memory 110, and supplies a clock signal to the normal image memory 109. On the other hand, in the case in which the remote control 10 or the remote control 30 is conducting power-saving operating behavior, the controller 103 (power supply controller 108) stops supplying a clock signal to the normal image memory 109, and supplies a clock signal to the reduced image memory 110. According to such a configuration, it is likewise possible to prevent the consumption of power by the memory that is not in use.

In addition, in the foregoing embodiments, since the reduced image memory 110 and the normal image memory 109 do not include a built-in CPU, the supply and non-supply of power to the reduced image memory 110 or the normal image memory 109 is conducted using field-effect transistors FET1 and FET2, but the configuration is not limited thereto. In other words, in the case in which a CPU is built into the reduced image memory 110 and the normal image memory 109, the supply and non-supply of power to the reduced image memory 110 or the normal image memory 109 may also be controlled by the built-in CPU.

The above may be configured as follows. Namely, the field-effect transistors FET1 and FET2 are removed from the circuit diagrams illustrated in FIGS. 3 and 8. Additionally, the respective terminals that were connected to each drain of the field-effect transistors FET1 and FET2 are respectively connected to the bus line BL. Furthermore, the storage battery 101 or the power supply 134 is connected to each of the reduced image memory 110 and the normal image memory 109 using leads and DC power of the storage battery 101 or the power supply 134 may be supplied to each of the reduced image memory 110 and the normal image memory 109. Also, the CPU built into the reduced image memory 110 and the normal image memory 109 may be configured to supply DC power from the storage battery 101 or the power supply 134 whether the remote control 10 or the remote control 30 is conducting normal operating behavior, or whether the remote control 10 or the remote control 30 is conducting power-saving operating behavior. With this configuration, the built-in CPU becomes able to operate whether the remote control 10 or the remote control 30 is conducting normal operating behavior, or whether the remote control 10 or the remote control 30 is conducting power-saving operating behavior.

Additionally, in the case in which the remote control 10 or the remote control 30 is conducting normal operating behavior, the controller 103 (power supply controller 108) outputs a supply command to the CPU built into the normal image memory 109 and outputs a non-supply command to the CPU built into the reduced image memory 110 via the bus line BL, thereby providing a supply of power to the normal image memory 109 and a non-supply of power to the reduced image memory 110. On the other hand, in the case in which the remote control 10 or the remote control 30 is conducting power-saving operating behavior, the controller 103 (power supply controller 108) may output a non-supply command to the CPU built into the normal image memory 109 and output a supply command to the CPU built into the reduced image memory 110 via the bus line thereby providing a non-supply of power to the normal image memory 109 and a supply of power to the reduced image memory 110. According to this configuration, the remote control 10 or the remote control 30 is likewise able to prevent power from being consumed by the memory that is not in use in the case in which the remote control 10 or the remote control 30 is conducting power-saving operating behavior.

Note that in the foregoing embodiments, a program that controls the air conditioning system 1 and the air conditioning system 2 may be stored and distributed on a computer-readable recording medium such as a flexible disk, a CD-ROM (Compact Disc-Read-Only Memory), a. DVD (Digital Versatile Disc), or a MO (Magneto-Optical disc), such that by installing the program on a computer or the like, an air conditioning system that executes the processes illustrated in FIGS. 5 to 7 and FIGS. 10 and 11 is configured.

Also, the above program is potentially stored in a disk device or the like included in a designated server device on a communication network such as the Internet, in which the program is impressed onto a carrier wave and downloaded or the like, for example.

Also, in the case in which the processes illustrated in FIGS. 5 to 7 and FIGS. 10 and 11 discussed above are realized under the supervision of an OS (Operating System), realized by cooperative action between an OS and an application, or the like, it is possible for only the portions other than the OS to be stored and distributed on a medium, or alternatively, downloaded or the like.

Various embodiments and modifications of the present disclosure are possible without departing from the scope and spirit of the present disclosure in the broad sense. Furthermore, the foregoing embodiments are for the purpose of describing the present disclosure, and do not limit the scope of the present disclosure. In other words, the scope of the present disclosure is indicated by the claims rather than the foregoing embodiments. In addition, various alterations performed within the scope of the claims or within an equivalent scope of the significance of the present disclosure are to be regarded as being within the scope of the present disclosure.

### INDUSTRIAL APPLICABILITY

The present disclosure is suitable for minimizing consumed power,

### REFERENCE SIGNS LIST

1, 2 air conditioning system
10, 30 remote control
20, 41_1, 41_2 air conditioner
40 controller
101 storage battery
102 A/D converter
103, 201, 401 controller
109 normal image memory
110 reduced image memory
111 screen layout information memory
120 RAM
130 input device
131 LCD controller
132 LCD
133, 136, 203, 406 communication device
134 power supply
204 control operation information storage
404 consumable power memory
405 floor space memory
407 interface
408 input device
409 display
410 speaker
BL bus line

1. A control device that receives a control operation for controlling equipment to be controlled, and transmits control information according to the received control operation to the equipment to be controlled, comprising:
a display that displays a control screen;
an information memory that stores first image information, being image information of image pixels that form a control screen displayed on the display;
a reduced information memory that stores second image information, being image information of the image pixels and having an amount of information that is less than that of image information stored in the information memory;
an operating mode setter that sets an operating mode of the control device to one of a first operating mode that operates with designated power consumption, and a second operating mode with lower power consumption than the first operating mode; and
a screen generator that, when the operating mode setter has set the first operating mode, reads first image information stored in the information memory and generates a control screen made up of a plurality of image pixels, and when the operating mode setter has set the second operating mode, reads second image information stored in the reduced information memory and generates a control screen made up of a plurality of image pixels and displays the generated control screen on the display.

2-6. (canceled)

7. A control method comprising:
an operating mode setting step in which a control device that includes a display that displays a control screen, receives a control operation for controlling equipment to be controlled, and transmits control information according to the received control operation to the equipment to be controlled, sets an operating mode to one of a first operating mode that operates with designated power consumption, and a second operating mode with lower power consumption than the first operating mode; and
a screen generating step in which the control device, when the first operating mode has been set by the operating mode setting step, reads first image information, being image information of image pixels that form a control screen, and generates the control screen, and when the second operating mode has been set by the operating mode setting step, reads second image information, being image information of the image pixels and having a smaller amount of information than that of the first image information, and generates the control screen, and displays the generated control screen on the display.

8. A non-transitory computer-readable recording medium storing a program causing a computer that controls a control device that includes a display that displays a control screen, receives a control operation for controlling equipment to be controlled, and transmits control information according to the received control operation to the equipment to be controlled to realize:
an operating mode setting function that sets an operating mode of the control device to one operating mode from a first operating mode that operates with designated power consumption, and a second operating mode with lower power consumption than the first operating mode; and
a screen generating function that, when the first operating mode has been set by the operating mode setting function, reads first image information, being image information of image pixels that form a control screen, and generates the control screen, and when the second operating mode has been set by the operating mode setting function, reads second image information, being image information of the image pixels and having a smaller amount of information than that of the first image information, and generates the control screen, and displays the generated control screen on the display.

9. The control device according to claim 1, wherein
the operating mode setter receives a command for setting the operating mode based on the result of the comparison of power consumption estimated to be consumed at the equipment to be controlled and consumable power designated to the equipment to be controlled as consumable power, and sets the operating mode in response to the received command.

10. The control device according to claim 1, further comprising:
a control information transmitter that transmits the control information according to the received operation to the equipment to be controlled at either the first operating mode or the second operating mode set at the operating mode setter.

11. The control device according to claim 1, wherein
when the operating mode setter applies a setting that switches one of the first operating mode and the second operating mode to the other, the screen generator reads image information that corresponds to image pixels making up a control screen that was being displayed on the display immediately before switching, and also corresponds to the operating mode after switching, and generates and displays a control screen on the display.

12. The control device according to claim 1, further comprising:
a power supply controller that, when the operating mode setter applies a setting that switches from the first operating mode to the second operating mode, shuts off power being supplied to the information memory, and starts a supply of the power to the reduced information memory that had been shut off.

13. The control device according to claim 1, wherein the operating mode setter,
by detecting an output voltage of a storage battery that supplies power to be consumed by the control device, and comparing the detected output voltage to a designated value, applies a setting that switches from the first operating mode to the second operating mode in a case of detecting that the output voltage is less than the designated value.
